(19) United States
(12) Patent Application Publication
(10) Pub. No.: US 2005/0144258 A1
(43) Pub. Date: Jun. 30, 2005

(54) Method and system for facilitating associating content with a portion of a presentation to which the content relates

(76) Inventors: Erik J. Burckart, Raleigh, NC (US); James Patrick Galvin JR., Oak Ridge, NC (US); Brian Pulito, Lexington, KY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/736,179

(22) Filed: Dec. 15, 2003

(51) Int. Cl. G06F 15/16

(52) U.S. Cl. 709/218; 709/204

(57) ABSTRACT

The present invention facilitates associating content with a portion of a presentation to which the content relates. Methods are provided in which a presentation is received by a client computer to be sequentially presented. Content is input during the presentation, the content relating to a particular portion of the presentation. The content, and an indication of an association between the content and the portion of the presentation to which the content relates, are stored. The stored indication is transmitted for use in retrieving the portion of the presentation to which the input content relates in association with the input content.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

When presenting in front of a group of people it is often convenient to show demonstrations and to have visual aids to help in the conveying of information. Currently presentations often involve the use of electronic slides. Products such as Microsoft PowerPoint have become valuable tools in providing electronic visual aids to presenters.

Products such as PowerPoint enable an individual giving a presentation to progress through a series of electronic slides that aid the viewer in following the content of the presentation. The slides may contain key points to which the presenter or narrator is focusing or they may contain diagrams or images to which the presenter may refer.

In giving a presentation, the presenter may wish to show a multimedia or video stream to the audience. This usually involves showing a movie or playing an audio track accompanying the presenter's narrative.

With current enterprises today spread over large geographic areas, it becomes difficult to gather employees in a single location. In such a case, when potential audience members are not within geographic proximity, presentations to fellow employees or group members may be difficult. In order to overcome this limitation software has been developed to allow presentations to be conducted over the Internet or over corporate networks. Software such as Lotus Sametime allows an individual to give a presentation to a remote audience. The audience may view the presentation using a web browser and is no longer required to be present at a single location. Such remote presentations may include slides or multimedia as well as a video stream of the presenter giving the talk.

It is often the case in presentations, both online and in person, that audience members have questions regarding the content of the presentation. Frequently the questions refer to a specific slide or a specific moment in the multimedia stream. In those cases the audience member may either interrupt the presentation to ask the question or he must wait until the speaker has completed his talk. If the speaker postpones all questions until the end of the talk, or if the presentation is being conducted remotely where the audience cannot interrupt by raising a hand or shouting, the context of the question may be lost. Any questions asked at the end based on the context of a particular slide or moment will require the presenter to rewind through the presentation in order to return to the context in which the question was asked. This is often a cumbersome, time-consuming process that must be repeated for every question asked.

What is lacking is a mechanism that alleviates the need for a presenter to return the context of the presentation at a particular time. By doing so questions asked regarding a particular time during the presentation may be answered without the need for cumbersome backtracking and searching.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a display of a user interface screen in accordance with an embodiment of the invention;

FIG. 2 is network architecture diagram in accordance with an embodiment of the invention;

FIG. 3 is a network architecture diagram with one possible usage scenario in accordance with an embodiment of the invention; and,

FIG. 4 is a flow chart illustrating a process for storing context with questions or comments in a slide presentation in accordance with an embodiment of the invention.

### SUMMARY OF THE INVENTION

In some embodiments, the present invention provides methods and systems for facilitating associating content with a portion of a presentation to which the content relates. Methods are provided in which a presentation is received by a client computer to be sequentially presented. Content is input during the presentation, the content relating to a particular portion of the presentation. The content, and an indication of an association between the content and the portion of the presentation to which the content relates, are stored. The stored indication is transmitted for use in retrieving the portion of the presentation to which the input content relates in association with the input content.

In one embodiment, the invention provides a method for facilitating associating content with a portion of a presentation to which the content relates. The method includes receiving from a server computer at a client computer a presentation to be sequentially presented. The method further includes, during sequential presenting of the presentation on the client computer, allowing input of content, the content relating to a portion of the presentation. The method further includes storing the input content, and an indication of an association between the input content and the portion of the presentation to which the input content relates. The method further includes transmitting the stored indication for use in retrieving the portion of the presentation to which the input content relates in association with the input content.

In another embodiment, the invention provides a method for facilitating associating content with a portion of a presentation to which the content relates. The method includes transmitting the presentation from a server computer to a client computer to be sequentially presented. The method further includes receiving and storing input content associated with a portion of the presentation, and an indication of the portion of the presentation to which the input content relates. The method further includes using the stored indication to present the portion of the presentation to which the input content relates in association with the input content.

In another embodiment, the invention provides a system for facilitating associating content with a portion of a presentation to which the content relates. The system includes a server computer and a client computer connected to the server computer. The client computer is for receiving from the server computer a presentation to be sequentially presented. The client computer is further for, during sequential presenting of the presentation on the client computer, allowing input of content, the content relating to a portion of the presentation. The client computer is further for storing the input content, and an indication of an association between the input content and the portion of the presentation to which the input content relates. The client computer is further for transmitting the stored indication for use in retrieving the portion of the presentation to which the input content relates in association with the input content.

In another embodiment, the invention provides a system for facilitating associating content with a portion of a presentation to which the content relates. The system includes a server computer and a client computer connected to the server computer. The server computer is for transmitting the presentation from a server computer to a client computer to be sequentially presented. The server computer is further for receiving and storing input content associated with a portion of the presentation, and an indication of the portion of the presentation to which the input content relates. The server computer is further for using the stored indication to present the portion of the presentation to which the input content relates in association with the input content.

In another embodiment, the invention provides a computer usable medium or computer useable media storing program code which, when executed on one or more computerized devices, causes the computerized devices to execute a method for facilitating associating input content with a portion of a presentation to which the content relates. The method includes receiving from a server computer at a client computer a presentation to be sequentially presented. The method further includes, during sequential presenting of the presentation on the client computer, allowing input of content, the content relating to a portion of the presentation. The method further includes storing the input content, and an indication of an association between the input content and the portion of the presentation to which the input content relates. The method further includes transmitting the stored indication for use in retrieving the portion of the presentation to which the input content relates in association with the input content.

In another embodiment, the invention provides a computer usable medium or computer useable media storing program code which, when executed on one or more computerized devices, causes the computerized devices to execute a method for facilitating associating input content with a portion of a presentation to which the content relates. The method includes transmitting the presentation from a server computer to a client computer to be sequentially presented. The method further includes receiving and storing input content associated with a portion of the presentation, and an indication of the portion of the presentation to which the input content relates. The method further includes using the stored indication to present the portion of the presentation to which the input content relates in association with the input content.

### DETAILED DESCRIPTION OF THE PREFFERED EMBODIMENTS

Embodiments of the present invention are now described in detail with reference to the drawings in the figures. As described in more detail, the present invention, in some embodiments, provides a system and method for associating questions asked during an electronic presentation to a particular context. In addition, in some embodiments, the present invention describes a system and method facilitating associating questions or comments to a context of the presentation to which the question or comment relates. In addition, in some embodiments, the present invention describes a system and method for retrieving a particular portion of first content, the first content being sequentially presented while a second content may be entered.

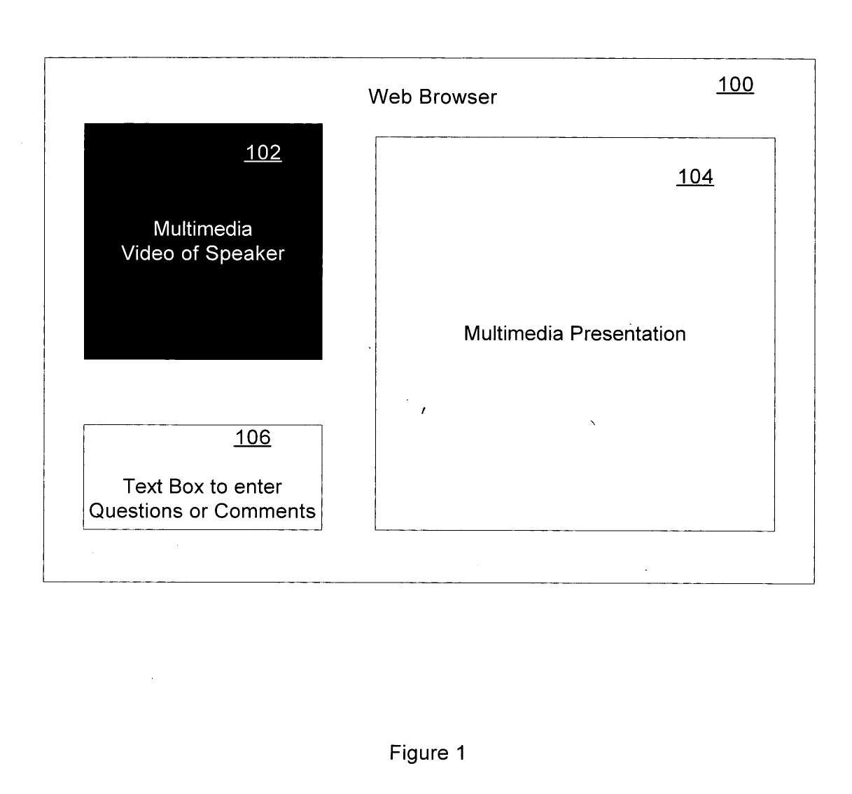

FIG. 1 illustrates one embodiment of a screen that may be displayed to viewers of an online presentation. In this embodiment the presentation is viewed within a web browser 100. A viewer of the presentation may view the speaker, presenter or moderator in a video window 102. Slides or a multimedia stream that the moderator is showing may be viewed in another multimedia window 104. In addition the presentation window 100 may contain a window or screen section 106 to enter text for questions or comments.

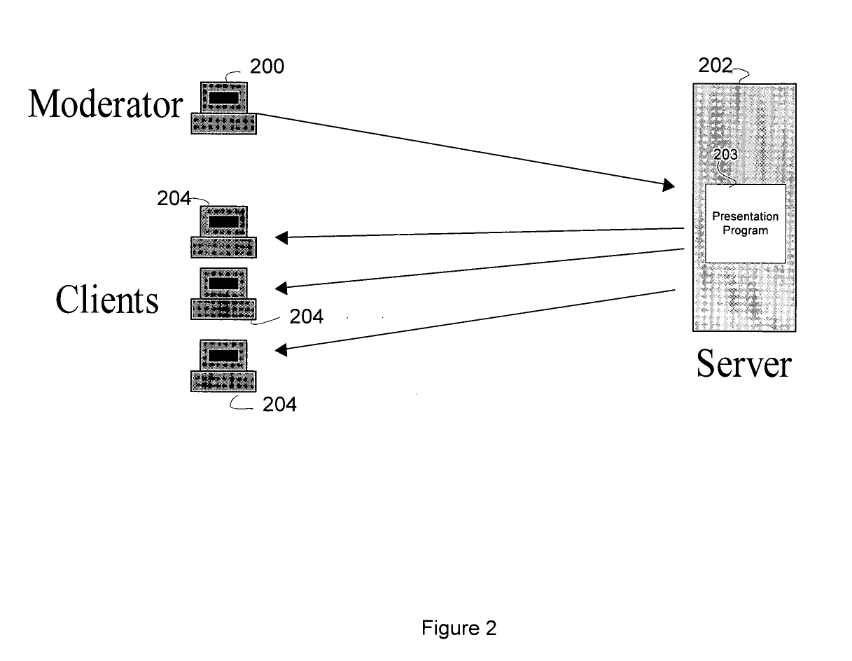

FIG. 2 shows one embodiment of a system to facilitate an online presentation. A moderator gives the presentation from a networked device 200. A device may be a computer, a handheld device or any device connected to a computer network. Additionally a computer may refer to any computerized device, including handhelds, desktops, and laptops. Additionally networked devices may be connected to the network using any network protocol including both wired and wireless. The networked device from which the moderator is giving the presentation pushes content to a server 202 through a computer network such as the Internet or an enterprise intranet. The server 202 distributes the content to client devices 204, which are connected to a computer network, which is communicatively coupled to the server computer 202. The server 202 pushes content to the clients 204. In order to facilitate functions according to an embodiment of the invention, the server executes a presentation program 203. The presentation program 203 may broadly contain or include, among other things, software, modules, components, programming tools, and libraries. In addition, the presentation program 203 may be split among multiple devices or computers, and may execute as sub-programs or objects within multiple operating environments.

In other embodiments, the server may pull content from the moderator device 200 and the client devices 204 may pull content from the server. In some embodiments, the moderator device 200 may also act as a client device 204.

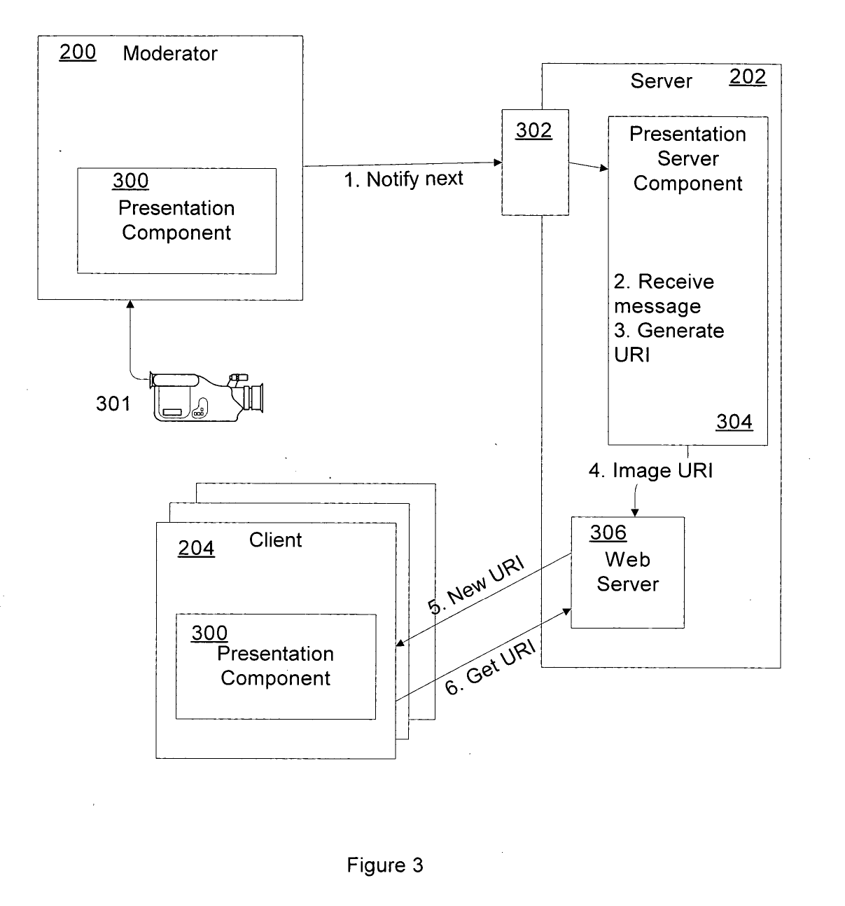

FIG. 3 shows a more detailed description of how, in one embodiment, the online presentation is distributed through a computer network. A moderator uses a moderator device 200 such as a computer, which is connected to a computer network. One module executed by the moderator computer 200 is a presentation component 300. In presenting an online presentation the moderator computer may have a video camera 301 to transmit audio or video of the moderator giving the presentation. In some cases, moderators may wish to show electronic slides during the presentation. During the presentation the moderator may wish to switch slides as the presentation progresses. In this embodiment, when the moderator changes slides on his local presentation software the presentation component 300 is notified. The presentation component 300 sends a message to the server 202 indicating that the slide has changed and containing an image of the next slide to be viewed. The server receives that message at a network interface 302 and passes it to a presentation server component 304, executing on the server 202.

The presentation server component 304 receives the image of the next slide and generates an identifier, such as a uniform resource indicator (URI) for the image. The presentation server component 304 sends a message to a World Wide Web server 306 running on the server 202. The image of the new slide and the URI for the image are given to the web server 306. The presentation server component 304 sends a message to all clients 204, which are viewing the presentation. The client devices are executing a presentation component 300. The message from presentation server component 304 to the presentation component 300 on the clients 204 contains the URI for the image of the next slide. Upon receipt of the message containing the URI of the next slide image the presentation component 300 causes the browser within which the presentation is being viewed to download the image from the web server 306, based on the received URI.

During the presentation the viewer at a client computer 204 may wish to type a question or comment for the moderator. In one embodiment the viewer may type the question or comment in a text box in a browser window 106. When the viewer begins typing the question the presentation component 300 on the client computer 204 records the URI of the current slide image being viewed. When the viewer finishes typing the question or comment the question is sent to the presentation server component 304 along with the URI for the image being shown when the questioner began typing. The presentation server component saves the text of the question or comment along with the sent URI. When the moderator retrieves the list of questions from the presentation server component 304 both the question and the image associated with the URI are returned. By doing so the moderator will have available the context in which the question was asked.

In some embodiments presentations use multimedia streams rather than slides during the presentations. In these cases different mechanisms may be used to indicate the context of a question. Rather than sending a URI along with the text of a question or comment, an index or time-stamp may be sent indicating a point in time during the multimedia stream when the question was typed.

In some embodiments, the moderator presentation component 300, the server presentation component 302 and the viewer presentation component 300 may be executed on the same device or computer. Such an embodiment, may in some instances, be used when viewing a multimedia stream on a machine. If the viewer, for example, wishes to annotate the stream, the system may be used to record the context of the annotations. In such an embodiment, the moderator presentation component could stream the multimedia to a server running on the same computer, which transmits the multimedia to a viewer component running on the same computer, as well. Annotations typed and entered using the viewer presentation component would record the context of the annotations and facilitate retrieving the context after the completion of the multimedia stream.

In some embodiments, the present invention describes a system and method for retrieving a particular portion of first content, the first content being sequentially presented while a second content may be entered. An identifier may be used to identify a portion of the first content that is temporally related to the entry of the second content item. The identifier can be stored so as to facilitate retrieving the first content. The stored identifier may be used in retrieving the first content while reviewing the second content.

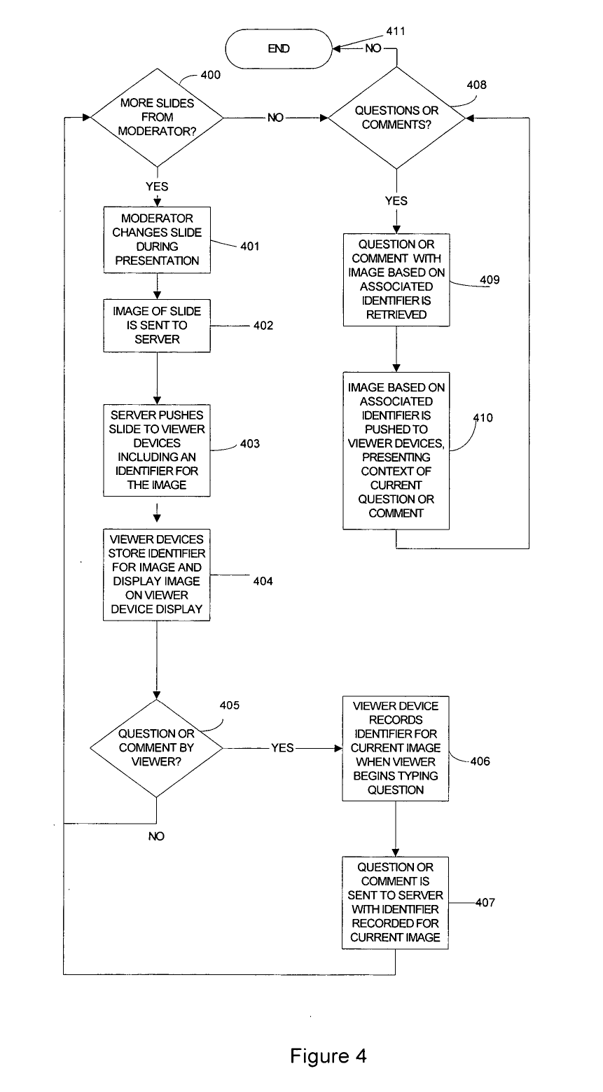

FIG. 4 shows one method of storing context information for questions and comments during an online presentation. If there are more slides to present, step 400, the moderator changes to the next slide, step 401. An image of the slide is sent to the server, step 402. The server pushes an image of the slide to the viewer devices, along with an associated identifier, step 403. The viewer devices store display the image of the next slide and record the identifier for the image, step 404. The viewer may have a question or comment regarding the now displaying slide, decision 405. If the viewer does have a question or comment the viewer device records the identifier for the currently displayed slide image that is being displayed when the viewer begins typing the question, step 406. The questions or comments are sent to the server with the associated identifier, step 407. The method then returns to decision 400. It is possible for the method to return to decision 400 before step 407 is completed. That is, the slide may change before questions or comments are submitted regarding previous slides. If the moderator no longer has additional slides to view there may be questions or comments that the moderator will address. If there are questions are comments to address, decision 408, questions or comments are retrieved to the moderator device along with the associated identifier, step 408.

When the moderator selects a question or comment to address the image associated with the identifier is pushed to the viewer devices, thereby loading the context associated with the question or comment. If there is another question or comment the steps repeat, otherwise the presentation ends 411.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for facilitating associating input content with a portion of a presentation to which the content relates, the method comprising:
receiving from a server computer at a client computer a presentation to be sequentially presented;
during sequential presenting of the presentation on the client computer, allowing input of content, the content relating to a portion of the presentation;
storing the input content, and an indication of an association between the input content and the portion of the presentation to which the input content relates; and
transmitting the stored indication for use in retrieving the portion of the presentation to which the input content relates in association with the input content.

2. The method of claim 1, comprising allowing input of content using the client computer.

3. The method of claim 1, wherein presenting the presentation comprises simultaneously presenting, using a first portion of a viewing area, a first multi-media presentation, and, in a second portion of the viewing area, a second multi-media presentation of at least one of a moderator, speaker, and presenter of the first multi-media presentation.

4. The method of claim 1, wherein presenting the presentation comprises simultaneously presenting, using a first portion of a viewing area, a multi-media presentation, and, in a second portion of the viewing area, an area for entry of input content, the input content comprising entered comments or questions relating to a portion of the multi-media presentation.

5. The method of claim 1, comprising storing on the client computer the input content, and an indication of an association between the input content and the portion of the presentation to which the input content relates.

6. The method of claim 1, wherein the input content is associated with the portion of the presentation by having been input at a time during the presenting of the portion of the presentation, and wherein storing the indication of the association comprises storing an indication of the portion of the presentation that was being presented at onset of input of the input content.

7. The method of claim 1, wherein the input content is associated with the portion of the presentation by having been input at a time during the presenting of the portion of the presentation, and wherein storing the indication of the association comprises storing an indication of time elapsed in the presentation when onset of input of the input content was occurred.

8. The method of claim 1, comprising simultaneously presenting the presentation to a plurality of client computers, and comprising allowing users of each of the plurality of client computers to input content relating to portions of the presentation.

9. The method of claim 1, wherein the presentation is a slide show, and wherein storing an indication comprises storing an identifier identifying one or more slides of the slide show to which an entered comment or question relates.

10. The method of claim 1, wherein the presentation is a streaming multi-media presentation, and wherein storing an indication comprises storing an indication of a time during the presenting of the multi-media presentation with which the input content is associated.

11. The method of claim 10, wherein storing an indication comprises storing a time-stamp.

12. The method of claim 1, wherein storing an indication comprises storing a uniform resource indicator.

13. A method for facilitating associating content with a portion of a presentation to which the content relates, the method comprising:
transmitting the presentation from a server computer to a client computer to be sequentially presented;
receiving and storing input content associated with a portion of the presentation, and an indication of the portion of the presentation to which the input content relates; and
using the stored indication to present the portion of the presentation to which the input content relates in association with the input content.

14. A system for facilitating associating content with a portion of a presentation to which the content relates, the system comprising:
a server computer; and
a client computer connected to the server computer;
wherein the client computer is for:
receiving from the server computer a presentation to be sequentially presented;
during sequential presenting of the presentation on the client computer, allowing input of content, the content relating to a portion of the presentation;
storing the input content, and an indication of an association between the input content and the portion of the presentation to which the input content relates; and
transmitting the stored indication for use in retrieving the portion of the presentation to which the input content relates in association with the input content.

15. A system for facilitating associating content with a portion of a presentation to which the content relates, the system comprising:
a server computer; and
a client computer connected to the server computer;
wherein the server computer is for:
transmitting the presentation from a server computer to a client computer to be sequentially presented;
receiving and storing input content associated with a portion of the presentation, and an indication of the portion of the presentation to which the input content relates; and
using the stored indication to present the portion of the presentation to which the input content relates in association with the input content.

16. A computer usable medium or computer useable media storing program code which, when executed on one or more computerized devices, causes the computerized devices to execute a method for facilitating associating input content with a portion of a presentation to which the content relates, the method comprising:
receiving from a server computer at a client computer a presentation to be sequentially presented;
during sequential presenting of the presentation on the client computer, allowing input of content, the content relating to a portion of the presentation;
storing the input content, and an indication of an association between the input content and the portion of the presentation to which the input content relates; and
transmitting the stored indication for use in retrieving the portion of the presentation to which the input content relates in association with the input content.

17. A computer usable medium or computer useable media storing program code which, when executed on one or more computerized devices, causes the computerized devices to execute a method for facilitating associating input content with a portion of a presentation to which the content relates, the method comprising:
transmitting the presentation from a server computer to a client computer to be sequentially presented;
receiving and storing input content associated with a portion of the presentation, and an indication of the portion of the presentation to which the input content relates; and
using the stored indication to present the portion of the presentation to which the input content relates in association with the input content.
